(19) United States
(12) Patent Application Publication
(10) Pub. No.: US 2026/0108072 A1
(43) Pub. Date: Apr. 23, 2026

(54) ARM SUPPORT DEVICE

(71) Applicant: Krystina Gore, Kelso, WA (US)

(72) Inventor: Krystina Gore, Kelso, WA (US)

(21) Appl. No.: 19/049,565

(22) Filed: Feb. 10, 2025

Related U.S. Application Data
(60) Provisional application No. 63/710,064, filed on Oct. 22, 2024.

(51) Int. Cl. A47C 16/00; B43L 15/00; F41C 33/00

(52) U.S. Cl. CPC A47C 16/00; F41C 33/001; B43L 15/00

(57) ABSTRACT

The subject matter disclosed and claimed herein, in one embodiment thereof, comprises an arm support device. The device is a set of supports that provide stability to an arm of a user during different activities or tasks. The arm support device comprises a wrist supporting component and an elbow supporting component. Both the wrist supporting component and the elbow supporting component feature a hinged area of support or ball and socket joint attached to the user's wrist or elbow via at least one compression sleeve. The unhinged ends of both the elbow supporting component and wrist supporting component feature a non-slip base. Thus, once either component of the device is secured to the corresponding area of the user's arm via the compression sleeve(s), the user can complete a multitude of tasks with extra wrist or elbow stability.

### CROSS-REFERENCE TO RELATED APPLICATION

The present application claims priority to, and the benefit of, U.S. Provisional Application No. 63/710,064, which was filed on Oct. 22, 2024, and is incorporated herein by reference in its entirety.

### FIELD OF THE INVENTION

The present invention relates generally to the field of arm support devices. More specifically, the present invention relates to an wrist or elbow support that can be worn to elevate the arm and shoulder for different tasks and activities. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in arm support devices. Generally, trying to keep the shoulders, elbows, and wrists steady while using a firearm can be difficult. Individuals with limited strength and dexterity may not be able to properly support their wrist or elbow for different activities. Individuals with shoulder issues may have trouble getting up and holding their arms up for long periods of time.

Accordingly, there is a demand for an improved arm support device that provides arm support for a variety of activities. More particularly, there is a demand for an ArmEase or arm support device that can support the arm at the wrist or elbow.

Therefore, there exists a long felt need in the art for an ArmEase or arm support device that provides users with an wrist or elbow support that can be worn to elevate or support the arm and shoulder for different tasks and activities. There is also a long felt need in the art for an ArmEase or arm support device that enables users to wear the device via a compression sleeve and firmly secure it to the body. Further, there is a long felt need in the art for an ArmEase or arm support device that reduces strain on the shoulders and arms while holding an object steady, such as a firearm. Moreover, there is a long felt need in the art for a device that utilizes an extendable, non-slip base to keep the device stable when placed on a flat surface, or may further comprise a clamp. Finally, there is a long felt need in the art for an ArmEase or arm support device that offers a way to support the wrist and elbow while shooting a firearm, painting, and numerous other tasks and activities.

The subject matter disclosed and claimed herein, in one embodiment thereof, comprises an ArmEase or arm support device. The device is a set of supports that provide stability to an arm of a user during different activities or tasks. The ArmEase or arm support device comprises a wrist supporting component and an elbow supporting component. Both the wrist supporting component and the elbow supporting component feature a hinged area of support or a ball and socket joint attached to the user's wrist or elbow via at least one compression sleeve. The unhinged ends of both the elbow supporting component and wrist supporting component feature a non-slip base. Thus, once either component of the device is secured to the corresponding area of the user's arm via the compression sleeve(s), the user can complete a multitude of tasks with extra wrist or elbow stability. Accordingly, the device helps those with limited strength or dexterity to properly support their wrist or elbow for different activities.

In this manner, the ArmEase or arm support device of the present invention accomplishes all of the forgoing objectives and provides users with a device that supports the arm either at the elbow or the wrist. The device is comprised of a wrist support and an elbow support that can be used according to the nature of the task at hand and the physical needs of the user.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an ArmEase or arm support device. The device is a set of supports that provide stability to an arm of a user during different activities or tasks. The ArmEase or arm support device comprises a wrist supporting component and an elbow supporting component. Both the wrist supporting component and the elbow supporting component feature a hinged area of support or a ball and socket joint attached to the user's wrist or elbow via at least one compression sleeve. The unhinged ends of both the elbow supporting component and wrist supporting component feature a non-slip base. Thus, once either component of the device is secured to the corresponding area of the user's arm via the compression sleeve(s), the user can complete a multitude of tasks with extra wrist or elbow stability.

In one embodiment, the ArmEase or arm support device of the present invention assists any setting in which extra wrist or elbow support can be appreciated, including shooting a firearm, painting, or other tasks. The wrist supporting component or elbow supporting component of the ArmEase or arm support device secures easily to a user's wrist or elbow to provide extra support. The ArmEase or arm support device enables users to wear the device via a compression sleeve and firmly secure it to the body. The ArmEase or arm support device reduces strain on the shoulders and arms while holding an object steady, such as a firearm. The ArmEase or arm support device utilizes an extendable, non-slip base to keep the device stable when placed on a flat surface.

In one embodiment, the ArmEase or arm support device comprises a wrist supporting component. The wrist supporting component is used to stabilize the wrist of a user and is comprised of a compression sleeve, an area of support, a non-slip base, and either a hinge or a ball and socket joint. The compression sleeve is placed around the wrist to secure the device to the user. The area of support supports the weight of the user's wrist. The non-slip base enables for a secure connection between the device and a horizontal flat surface. The hinge or ball and socket joint enable for adjustment of the device.

In one embodiment, the ArmEase or arm support device comprises an elbow supporting component. The elbow supporting component is used to stabilize the elbow of a user and is comprised of a compression sleeve, an area of support, a non-slip base, and either a hinge or a ball and socket joint. The compression sleeve is placed around the elbow to secure the device to the user. The area of support supports the weight of the user's elbow. The non-slip base enables for a secure connection between the device and a horizontal flat surface. The hinge or ball and socket joint enable for adjustment of the device.

In one embodiment, if the wrist supporting component and the elbow supporting component each feature a hinge, the hinges are collapsible for easy storage when not in use. In one embodiment, if the wrist supporting component and the elbow supporting component feature ball and socket joints, the non-slip base is selectively extendable to vertically adjust the device.

In one embodiment, the ArmEase or arm support device in accordance with the present invention can be produced in various colors, designs, patterns, etc., and feature logos, emblems and or designs, such as a distributor requests and/or a user desires.

In one embodiment, the ArmEase or arm support device is manufactured of a high-density polyethylene (HDPE), or any other suitable material as is known in the art. Any number of different types of materials can be used to make the ArmEase or arm support device including but not limited to plastics, nylon, textile materials, etc.

In use, the user secures either the wrist supporting component to the wrist or the elbow supporting component to the elbow via the compression sleeves. Further, the user positions the non-slip base on any horizontal flat surface. Finally, the user may utilize the device to stabilize the arm. Thus, once either component of the device is secured to the corresponding area of the user's arm via the compression sleeve(s), the user can complete a multitude of tasks with extra wrist or elbow stability.

It will also be appreciated that there are a number of additional add-on features that can be incorporated into the device and moreover, the ArmEase or arm support device can take many different forms as is known in the art.

In yet another embodiment, the ArmEase or arm support device comprises a plurality of indicia.

In yet another embodiment, a method of conveniently utilizing the ArmEase or arm support device to stabilize an arm is disclosed. The method includes the steps of providing an ArmEase or arm support device comprising a wrist supporting component, and an elbow supporting component, each comprising at least one compression sleeve and either a hinge or a ball and socket joint and a non-slip base. The method also comprises securing either the wrist supporting component to the wrist or the elbow supporting component to the elbow via the compression sleeves. Further, the method comprises positioning the non-slip base on any horizontal flat surface. Finally, the method comprises utilizing the device to stabilize the arm.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the ArmEase or arm support device of the present invention in accordance with the disclosed architecture;

FIG. 2 illustrates a perspective view of one embodiment of the ArmEase or arm support device of the present invention showing how the elbow supporting component is worn and how the non-slip base can expand in accordance with the disclosed architecture;

FIG. 3 illustrates a perspective view of one embodiment of the ArmEase or arm support device of the present invention showing the elbow supporting component in use while shooting a firearm in accordance with the disclosed architecture;

FIG. 4 illustrates a perspective view of one embodiment of the ArmEase or arm support device of the present invention showing the wrist supporting component being worn in accordance with the disclosed architecture;

FIG. 5 illustrates a perspective view of one embodiment of the ArmEase or arm support device of the present invention showing how the non-slip base extends and retracts from the ball and socket joint in accordance with the disclosed architecture; and

FIG. 6 illustrates a flowchart showing the method of conveniently utilizing the ArmEase or arm support device to stabilize an arm in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for an ArmEase or arm support device that provides users with an wrist or elbow support that can be worn to elevate the arm and shoulder for different tasks and activities. There is also a long felt need in the art for an ArmEase or arm support device that enables users to wear the device via a compression sleeve and firmly secure it to the body. Further, there is a long felt need in the art for an ArmEase or arm support device that reduces strain on the shoulders and arms while holding an object steady, such as a firearm. Moreover, there is a long felt need in the art for a device that utilizes an extendable, non-slip base to keep the device stable when placed on a flat surface. Finally, there is a long felt need in the art for an ArmEase or arm support device that offers a way to support the wrist and elbow while shooting a firearm, painting, and numerous other tasks and activities.

The subject matter disclosed and claimed herein, in one embodiment thereof, comprises an ArmEase or arm support device. The device is a set of supports that provide stability to an arm of a user during different activities or tasks. The ArmEase or arm support device comprises a wrist supporting component and an elbow supporting component. Both the wrist supporting component and the elbow supporting component feature a hinged area of support or ball and socket joint attached to the user's wrist or elbow via at least one compression sleeve. The unhinged ends of both the elbow supporting component and wrist supporting component feature a non-slip base. Thus, once either component of the device is secured to the corresponding area of the user's arm via the compression sleeve(s), the user can complete a multitude of tasks with extra wrist or elbow stability. The present invention also includes a novel method of conveniently utilizing the ArmEase or arm support device to stabilize an arm. The method includes the steps of providing an ArmEase or arm support device comprising a wrist supporting component and an elbow supporting component, each comprising at least one compression sleeve and either a hinge or a ball and socket joint and a non-slip base. The method also comprises securing either the wrist supporting component to the wrist or the elbow supporting component to the elbow via the compression sleeves. Further, the method comprises positioning the non-slip base on any horizontal flat surface. Finally, the method comprises utilizing the device to stabilize the arm.

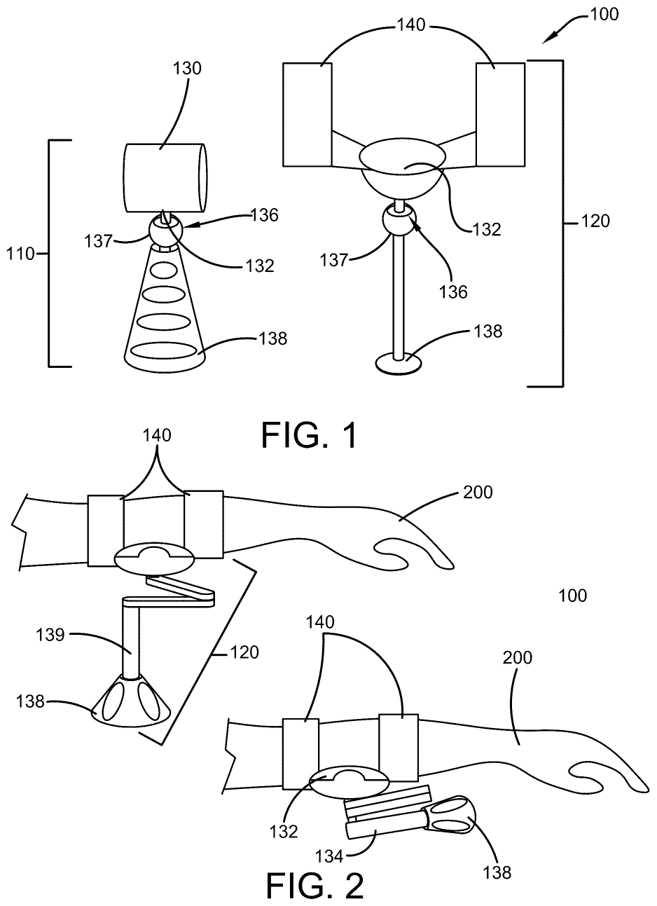

Referring initially to the drawings, FIG. 1 illustrates a perspective view of one embodiment of the ArmEase or arm support device 100 of the present invention. In the present embodiment, the ArmEase or arm support device 100 is an improved arm support device 100 that provides a user 200 supports for the wrist or elbow while performing various activities. Specifically, the ArmEase or arm support device 100 comprises a wrist supporting component 110 and/or an elbow supporting component 120. Thus, once either the wrist supporting component 110 or the elbow supporting component 120 of the device 100 is secured to the corresponding area of the user's 200 arm via the compression sleeve(s) 130, 140 the user 200 can complete a multitude of tasks with extra wrist or elbow stability.

Generally, the ArmEase or arm support device 100 of the present invention assists any setting in which extra wrist or elbow support can be appreciated, including shooting a firearm, painting, or other tasks. The wrist supporting component 110 or elbow supporting component 120 of the ArmEase or arm support device 100 secures easily to a user's wrist or elbow to provide extra support. The ArmEase or arm support device 100 enables users 200 to wear the device 100 via a compression sleeve 130, 140 and firmly secure it to the body. The ArmEase or arm support device 100 reduces strain on the shoulders and arms while holding an object steady, such as a firearm. The ArmEase or arm support device 100 utilizes an extendable, non-slip base 138 to keep the device 100 stable when placed on a flat surface. Alternatively, the ArmEase or arm support device 100 may also comprise a clamp 140 that could be attached to a tree branch, arm, chair or the like.

As shown in FIG. 4, the ArmEase or arm support device 100 comprises a wrist supporting component 110. The wrist supporting component 110 is used to stabilize the wrist of a user 200 and is comprised of a compression sleeve 130, an area of support 132, a non-slip base 138, and either a hinge 134 or a ball and socket joint 136. The compression sleeve 130, 140 is placed around the wrist or elbow to secure the device 100 to the user 200. The area of support 132 supports the weight of the user's wrist or elbow. The non-slip base 138 enables for a secure connection between the device 100 and a horizontal flat surface. The hinge 134 and/or ball and socket joint 136 enable for adjustment of the device 100. A threaded sleeve 137 partially encircles the ball and socket joint 136 for tightening against the ball and socket joint 136 to secure and lock the ball and socket joint 136 in a fixed orientation.

In one embodiment, the ArmEase or arm support device 100 comprises an elbow supporting component 120. The elbow supporting component 120 is used to stabilize the elbow of a user 200 and is comprised of a compression sleeve 140, an area of support 132, a non-slip base 138, and a connector comprising a hinge 134 or a ball and socket joint 136. The compression sleeve 140 is placed around the elbow to secure the device 100 to the user 200. The area of support 132 supports the weight of the user's elbow. The non-slip base 138 enables for a secure connection between the device 100 and a horizontal flat surface. The hinge 134 or ball and socket joint 136 enable for angular, pivotal, and/or swivel adjustment of the device 100.

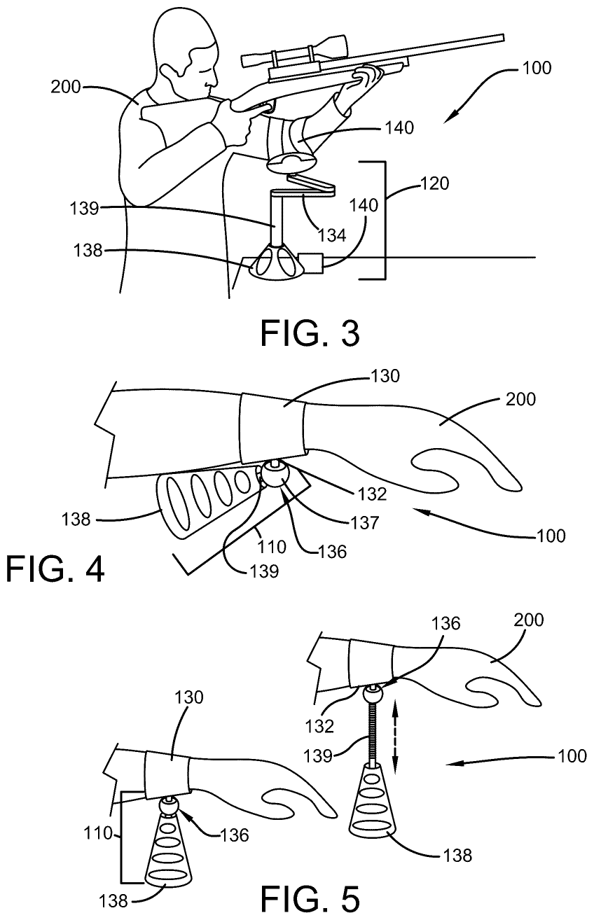

As shown in FIGS. 2 and 3, if the wrist supporting component 110 and the elbow supporting component 120 each feature a hinge 134, the hinges 134 are collapsible for easy storage when not in use. As shown in FIGS. 1, 4, and 5, if the wrist supporting component 110 and the elbow supporting component 120 feature ball and socket joints 136, the non-slip base 138 is connected to a threaded rod 139 for selective retraction and extension to vertically adjust a height of the device 100.

As shown in FIG. 3, in use, the user 200 secures either the wrist supporting component 110 to the wrist or the elbow supporting component 120 to the elbow via the compression sleeves 130, 140, respectively. Further, the user 200 positions the non-slip base 138 on any horizontal flat surface. Finally, the user 200 may utilize the device 100 to stabilize the arm. Thus, once either component of the device 100 is secured to the corresponding area of the user's arm via the compression sleeve(s) 130, 140, the user 200 can complete a multitude of tasks with extra wrist or elbow stability.

It is to be appreciated that the ArmEase or arm support device 100 in accordance with the present invention can be produced in various colors, designs, patterns, etc., and feature logos, emblems and or designs, such as a distributor requests and/or a user 200 desires.

In one embodiment, the ArmEase or arm support device 100 is manufactured of a high-density polyethylene (HDPE), or any other suitable materials as is known in the art. Any number of different types of materials can be used to make the ArmEase or arm support device 100 including but not limited to nylon, textile materials, heat-sealable plastic or polymers, such as polypropylene or acrylonitrile-butadiene-styrene (ABS), or any other suitable material as is known in the art, such as but not limited to, acrylic, polycarbonate, polyethylene, polyethylene terephthalate, polyvinyl chloride, polystyrene, etc. Generally, the compression sleeves 130, 140 of the ArmEase or arm support device 100 are comprised of a flexible, non-reflective, sweat absorbing, and scentless material.

In yet another embodiment, the ArmEase or arm support device 100 comprises a plurality of indicia 400. The wrist supporting component 110 or the elbow supporting component 120 of the device 100 may include advertising, a trademark, or other letters, designs, or characters, printed, painted, stamped, or integrated into the body component 102, or any other indicia 400 as is known in the art. Specifically, any suitable indicia 400 as is known in the art can be included, such as but not limited to, patterns, logos, emblems, images, symbols, designs, letters, words, characters, animals, advertisements, brands, etc., that may or may not be hunting, painting, or brand related.

It will also be appreciated that there are a number of additional add-on features that can be incorporated into the device 100 and moreover, the ArmEase or arm support device 100 can take many different forms as is known in the art.

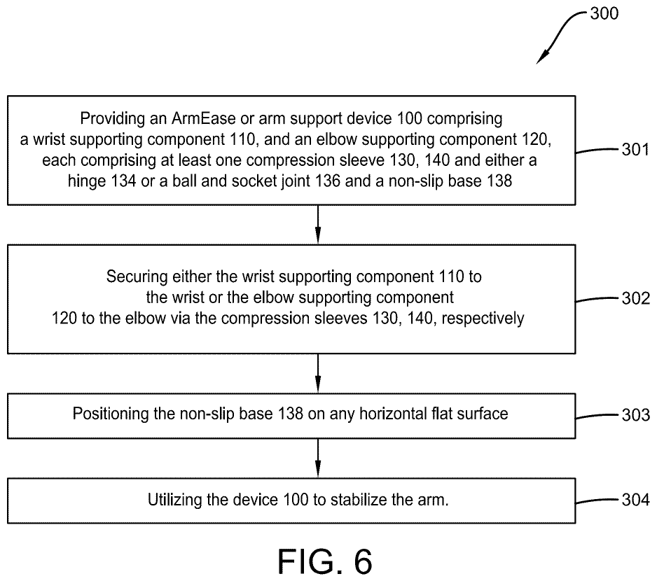

FIG. 6 illustrates a flowchart of the method 300 of conveniently utilizing the ArmEase or arm support device 100 to stabilize an arm. The method includes the steps of at 301, providing an ArmEase or arm support device 100 comprising a wrist supporting component 110, and an elbow supporting component 120, each comprising at least one compression sleeve 130, 140 and either a hinge 134 or a ball and socket joint 136 and a non-slip base 138. The method also comprises at 302, securing either the wrist supporting component 110 to the wrist or the elbow supporting component 120 to the elbow via the compression sleeves 130, 140, respectively. Further, the method comprises at 303, positioning the non-slip base 138 on any horizontal flat surface. Finally, the method comprises at 304, utilizing the device 100 to stabilize the arm.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “ArmEase device”, “arm support device”, “support device”, and “device” are interchangeable and refer to the ArmEase or arm support device 100 of the present invention.

Notwithstanding the forgoing, the ArmEase or arm support device 100 of the present invention can be of any suitable size and configuration as is known in the art without affecting the overall concept of the invention, provided that it accomplishes the above stated objectives. One of ordinary skill in the art will appreciate that the ArmEase or arm support device 100 as shown in FIGS. 1-5 is for illustrative purposes only, and that many other sizes and shapes of the ArmEase or arm support device 100 are well within the scope of the present disclosure. Although the dimensions of the ArmEase or arm support device 100 are important design parameters for user convenience, the ArmEase or arm support device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An arm support device comprising:
an arm portion supporting component;
a user's arm;
a compression sleeve;
a base; and
a connector;
wherein said compression sleeve securable to an area of the user's arm;
wherein said base attached at one end to said compression sleeve with said connector;
wherein said base restable at another end upon a flat surface;
wherein said connector is selectively extendable for adjusting a height of said base; and
further wherein said connector pivotal for angular adjustment of said arm portion supporting component.

2. The arm support device of claim 1, wherein said arm portion supporting component selected from the group consisting of a wrist supporting component and an elbow supporting component.

3. The arm support device of claim 2, wherein said connector selected from one or more of the group consisting of a hinge, a threaded rod, and a ball and socket joint.

4. The arm support device of claim 3, wherein said another end of said base is a non-slip end.

5. The arm support device of claim 4, wherein said compression sleeve wearable around the area of the user's arm.

6. The arm support device of claim 2, wherein said compression sleeve wearable around a wrist of the user's arm for stabilizing a wrist of the user's arm.

7. The arm support device of claim 2, wherein said compression sleeve wearable around an elbow of the user's arm for stabilizing an elbow of the user's arm.

8. The arm support device of claim 5, wherein said arm portion supporting component having a material selected from the group consisting of a nylon, a textile material, a heat-sealable polymer, a polypropylene, an acrylonitrile-butadiene-styrene (ABS), an acrylic, a polycarbonate, a polyethylene, a polyethylene terephthalate, a polyvinyl chloride, and a polystyrene.

9. An arm support device comprising:
an elbow supporting component;
a user's arm;
a compression sleeve;
a base; and
a connector;
wherein said compression sleeve securable to an elbow area of the user's arm;
wherein said base attached at one end to said compression sleeve with said connector;
wherein said base restable at another end upon a flat surface;
wherein said connector is selectively extendable for adjusting a height of said base; and
further wherein said connector pivotable and securable for fixing an angle of said elbow supporting component.

10. The arm support device of claim 9, wherein said compression sleeve having a first portion wrapped around an area below the elbow and a second portion wrapped around an area above the elbow.

11. The arm support device of claim 10, wherein said connector selected from one or more of the group consisting of a hinge, a threaded rod, and a ball and socket joint.

12. The arm support device of claim 11, wherein said another end of said base is a non-slip end.

13. The arm support device of claim 9, wherein said compression sleeve wearable around an elbow of the user's arm for stabilizing an elbow of the user's arm.

14. The arm support device of claim 13, wherein said elbow supporting component having a material selected from the group consisting of a nylon, a textile material, a heat-sealable polymer, a polypropylene, an acrylonitrile-butadiene-styrene (ABS), an acrylic, a polycarbonate, a polyethylene, a polyethylene terephthalate, a polyvinyl chloride, and a polystyrene.

15. An arm support device comprising:
a wrist supporting component;
a user's arm;
a compression sleeve;
a base; and
a connector;
wherein said compression sleeve securable to a wrist area of the user's arm;
wherein said base attached at one end to said compression sleeve with said connector;
wherein said base restable at another end upon a flat surface;
wherein said connector is selectively extendable for adjusting a height of said base; and
further wherein said connector pivotable and securable for fixing an angle of said wrist supporting component.

16. The arm support device of claim 15, wherein said compression sleeve having a portion wrapped around the wrist area of the user's arm.

17. The arm support device of claim 16, wherein said connector selected from one or more of the group consisting of a hinge, a threaded rod, and a ball and socket joint.

18. The arm support device of claim 17, wherein said another end of said base is a non-slip end.

19. The arm support device of claim 15, wherein said compression sleeve wearable around a wrist of the user's arm for stabilizing a wrist of the user's arm.

20. The arm support device of claim 19, wherein said wrist supporting component having a material selected from the group consisting of a nylon, a textile material, a heat-sealable polymer, a polypropylene, an acrylonitrile-butadiene-styrene (ABS), an acrylic, a polycarbonate, a polyethylene, a polyethylene terephthalate, a polyvinyl chloride, and a polystyrene.
